(19) United States
(12) Patent Application Publication
(10) Pub. No.: US 2025/0169390 A1
(43) Pub. Date: May 29, 2025

(54) DEVICES, SYSTEMS AND METHODS FOR GUIDANCE LINE SHIFTING

(71) Applicant: Ag Leader Technology, Ames, IA (US)

(72) Inventor: Scott Eichhorn, Ames, IA (US)

(21) Appl. No.: 18/962,799

(22) Filed: Nov. 27, 2024

Related U.S. Application Data
(60) Provisional application No. 63/603,969, filed on Nov. 29, 2023.

(51) Int. Cl. A01B 69/04; B60W 60/00; G05D 1/43; G06Q 50/02

(52) U.S. Cl. CPC A01B 69/008; B60W 60/001; G05D 1/43; G06Q 50/02

(57) ABSTRACT

An adjustment system for guidance lines comprising a GNSS unit disposed on an agricultural vehicle, a memory comprising stored crop row locations, a processor in communication with the GNSS unit and the memory, the processor configured to apply lateral and/or longitudinal adjustments to guidance lines generated based on stored crop row locations from a prior operation, and an automatic steering system configured to command the agricultural vehicle to traverse the guidance lines.

### CROSS-REFERENCE TO RELATED APPLICATION(S)

This application claims the benefit under 35 U.S.C. § 119(e) to U.S. Provisional Application 63/603,969, filed Nov. 29, 2023, and entitled Device, Systems and Methods for Guidance Line Shifting, which is hereby incorporated herein by reference in its entirety for all purposes.

### TECHNICAL FIELD

The disclosure relates to devices, systems, and methods for agricultural navigation, guidance, and mapping and more particularly for updating crop position estimates by recording line nudges on subsequent operations.

### BACKGROUND

It is understood that under existing approaches, crop row location estimates generated by software will be imperfect, regardless of how the initial estimate is made. For example, one existing method of crop row location estimation places a GNSS receiver on the planter implement. With this method, sources of error include implement GNSS positional error, error in the implement GNSS antenna mounting location, error in the state estimation of the implement position, and error in the state estimation of the implement pose.

Another existing method for crop row location estimation combines the GNSS location and pose of the tractor along with a tractor-mounted sensor that measures the position of the implement relative to the tractor. With this method, sources of error include vehicle GNSS positional error, error in the vehicle GNSS antenna mounting location, error in the state estimation of the vehicle position, error in the state estimation of the vehicle pose, and error in measurement of the implement's pose relative to the tractor.

Yet another existing method combines the GNSS location and pose of the tractor along with a kinematic model estimating the position of the implement relative to the tractor. With this method, sources of error include vehicle GNSS positional error, error in the vehicle GNSS antenna mounting location, error in the state estimation of the vehicle position, error in the state estimation of the vehicle pose, and error in the state estimation measurement of the implement's pose relative to the tractor.

### BRIEF SUMMARY

Discussed herein are various implementations of navigation systems to be used with agricultural equipment. The various devices, systems, and methods disclosed are for adjusting and correcting recorded crop row locations to align with actual crop row locations for generation of and navigating guidance paths for efficient and accurate subsequent farming operations.

In the various examples and implementations described in detail here and throughout the disclosure, a system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In Example 1, a method for locating crop row and generating vehicle guidance paths comparing a recorded crop row location to an actual row location, adjusting the crop row location such that the recorded crop row location is aligned with the actual crop row location, generating guidance paths for a vehicle using the adjusted crop row locations, and commanding the vehicle to traverse the generated guidance paths via an automatic steering system.

Example 2 relates to the method of any of Example 1 and 3-9, wherein the recorded crop row location is taken from data recorded during planting operations.

Example 3 relates to the method of any of Example 1-2 and 4-9, wherein the actual crop row location is determined by a mechanical crop sensor.

Example 4 relates to the method of any of Example 1-3 and 5-9, wherein the adjustment is applied to an entire field.

Example 5 relates to the method of any of Example 1-4 and 6-9, wherein the adjustment is applied to only a segment of a field.

Example 6 relates to the method of any of Example 1-5 and 7-9, further comprising selecting a most accurate crop location estimate from the recorded crop row location and a current operation estimate.

Example 7 relates to the method of any of Example 1-6 and 8-9, wherein the recorded crop row location includes data from two or more GNSS sources, further comprising determining a most accurate source from the two or more GNSS sources.

Example 8 relates to the method of any of Example 1-7 and 9, wherein the most accurate source is selected by applying a Kalman filter.

Example 9 relates to the method of any of Example 1-8, further comprising discarding outlier recorded crop locations.

In Example 10, an adjustment system for guidance lines comprising a GNSS unit disposed on an agricultural vehicle, a memory comprising stored crop row locations, a processor in communication with the GNSS unit and the memory, the processor configured to apply lateral and/or longitudinal adjustments to guidance lines generated based on stored crop row locations from a prior operation, and an automatic steering system configured to command the agricultural vehicle to traverse the guidance lines.

Example 11 relates to the adjustment system of nay of Examples 10 and 12-16, further comprising a crop sensor configured to detect an actual location of a crop row.

Example 12 relates to the adjustment system of nay of Examples 10-11 and 13-16, wherein the crop sensor is a mechanical, contact sensor.

Example 13 relates to the adjustment system of nay of Examples 10-12 and 14-16, wherein lateral and/or longitudinal adjustment are applied to an entire field.

Example 14 relates to the adjustment system of nay of Examples 10-13 and 15-16, wherein lateral and/or longitudinal adjustment are applied to a segment of a field.

Example 15 relates to the adjustment system of nay of Examples 10-14 and 16, wherein the field is segmented by one or more of topology, crop type, crop treatment, soil type, planted crop population density, prior year yield maps, active implement steering parameters from prior operations, planting depth, recorded vehicle wheel slip, and prior operation timing.

Example 16 relates to the adjustment system of nay of Examples 10-15, wherein the GNSS unit is configure to record data from multiple sources continuously or periodically.

While multiple embodiments are disclosed, still other embodiments of the disclosure will become apparent to those skilled in the art from the following detailed description, which shows and describes illustrative embodiments of the invention. As will be realized, the disclosure is capable of modifications in various obvious aspects, all without departing from the spirit and scope of the disclosure. Accordingly, the drawings and detailed description are to be regarded as illustrative in nature and not restrictive.

### BRIEF DESCRIPTION OF THE DRAWINGS

FIG. 1A is a schematic view of the system implemented on an agricultural vehicle, according to one implementation.

FIG. 1B is a system diagram of the path system, according to one implementation.

FIG. 2A shows an exemplary aerial view of a field where the recorded crop row locations differ from actual crop row locations, according to one implementation.

FIG. 2B shows the exemplary aerial view from FIG. 2A where the system has nudged the recorded crop row locations to match the actual crop row locations, according to one implementation.

FIG. 3 shows an exemplary sloped terrain where the system applies selective shifting of crop row position based on the slope, according to one implementation.

FIG. 4A shows an exemplary aerial view of a field there the estimated crop row locations are smooth and continuous, according to one implementation.

FIG. 4B shows the exemplary aerial view from FIG. 4A where the estimated crop row locations are discontinuous, according to one implementation.

### DETAILED DESCRIPTION

The disclosed systems, methods, and devices represent a technological improvement to agricultural guidance and navigation systems and devices in that it establishes guidance paths for agricultural vehicles for traversing a field and/or performing desired operations when the previous/stored guidance paths are inaccurate. In certain implementations the system establishes guidance paths via a software-integrated display platform such as SteerCommand® or other platform that would be known and appreciated by those of skill in the art.

In certain implementations, these vehicle guidance paths may be used in agricultural operations, such as planting, harvesting, spraying, tilling, and other operations related to row crops, as would be readily appreciated. In these and other implementations, the vehicle guidance paths are used by an automatic, semi-automatic, or assisted steering system for commanding traversal of the guidance paths by an agricultural vehicle.

The disclosure relates to devices, systems and methods for updating crop position and guidance path estimates by recording and applying line nudges on subsequent operations. That is, in various implementations, recorded or otherwise estimated guidance lines and crop locations established during a first operation, such as planting or spraying, can be applied with adjustments to reflect real-world conditions on a subsequent operation, such as spraying or harvesting. It is understood that these are merely examples and that any agricultural operation can serve as the first and/or second operation.

Certain of the disclosed implementations can be used in conjunction with any of the devices, systems or methods taught or otherwise disclosed in U.S. Pat. No. 10,684,305 issued Jun. 16, 2020, entitled “Apparatus, Systems and Methods for Cross Track Error Calculation From Active Sensors,” U.S. patent application Ser. No. 16/121,065, filed Sep. 4, 2018, entitled “Planter Down Pressure and Uplift Devices, Systems, and Associated Methods,” U.S. Pat. No. 10,743,460, issued Aug. 18, 2020, entitled “Controlled Air Pulse Metering apparatus for an Agricultural Planter and Related Systems and Methods,” U.S. Pat. No. 11,277,961, issued Mar. 22, 2022, entitled “Seed Spacing Device for an Agricultural Planter and Related Systems and Methods,” U.S. patent application Ser. No. 16/142,522, filed Sep. 26, 2018, entitled “Planter Downforce and Uplift Monitoring and Control Feedback Devices, Systems and Associated Methods,” U.S. Pat. No. 11,064,653, issued Jul. 20, 2021, entitled “Agricultural Systems Having Stalk Sensors and/or Data Visualization Systems and Related Devices and Methods,” U.S. Pat. No. 11,297,768, issued Apr. 12, 2022, entitled “Vision Based Stalk Sensors and Associated Systems and Methods,” U.S. patent application Ser. No. 17/013,037, filed Sep. 4, 2020, entitled “Apparatus, Systems and Methods for Stalk Sensing,” U.S. patent application Ser. No. 17/226,002 filed Apr. 8, 2021, and entitled “Apparatus, Systems and Methods for Stalk Sensing,” U.S. Pat. No. 10,813,281, issued Oct. 27, 2020, entitled “Apparatus, Systems, and Methods for Applying Fluid,” U.S. patent application Ser. No. 16/371,815, filed Apr. 1, 2019, entitled “Devices, Systems, and Methods for Seed Trench Protection,” U.S. patent application Ser. No. 16/523,343, filed Jul. 26, 2019, entitled “Closing Wheel Downforce Adjustment Devices, Systems, and Methods,” U.S. patent application Ser. No. 16/670,692, filed Oct. 31, 2019, entitled “Soil Sensing Control Devices, Systems, and Associated Methods,” U.S. patent application Ser. No. 16/684,877, filed Nov. 15, 2019, entitled “On-The-Go Organic Matter Sensor and Associated Systems and Methods,” U.S. Pat. No. 11,523,554, issued Dec. 13, 2022, entitled “Dual Seed Meter and Related Systems and Methods,” U.S. patent application Ser. No. 16/891,812, filed Jun. 3, 2020, entitled “Apparatus, Systems and Methods for Row Cleaner Depth Adjustment On-The-Go,” U.S. Pat. No. 11,678,607, issued Jun. 20, 2023, entitled “Apparatus, Systems, and Methods for Eliminating Cross-Track Error,” U.S. patent application Ser. No. 16/921,828, filed Jul. 6, 2020, entitled “Apparatus, Systems and Methods for Automatic Steering Guidance and Visualization of Guidance Paths,” U.S. patent application Ser. No. 16/939,785, filed Jul. 27, 2020, entitled “Apparatus, Systems and Methods for Automated Navigation of Agricultural Equipment,” U.S. patent application Ser. No. 16/997,361, filed Aug. 19, 2020, entitled “Apparatus, Systems and Methods for Steerable Toolbars,” U.S. Pat. No. 11,785,881, issued Oct. 17, 2023, entitled “Adjustable Seed Meter and Related Systems and Methods,” U.S. patent application Ser. No. 17/011,737, filed Sep. 3, 2020, entitled “Planter Row Unit and Associated Systems and Methods,” U.S. Pat. No. 11,877,530 issued Jan. 23, 2024, entitled “Agricultural Vacuum and Electrical Generator Devices, Systems, and Methods,” U.S. patent application Ser. No. 17/105,437, filed Nov. 25, 2020, entitled “Devices, Systems and Methods For Seed Trench Monitoring and Closing,” U.S. patent application Ser. No. 17/127,812, filed Dec. 18, 2020, entitled “Seed Meter Controller and Associated Devices, Systems and Methods,” U.S. patent application Ser. No. 17/132,152, filed Dec. 23, 2020, entitled “Use of Aerial Imagery For Vehicle Path Guidance and Associated Devices, Systems, and Methods,” U.S. patent application Ser. No. 17/164,213, filed Feb. 1, 2021, entitled “Row Unit Arm Sensor and Associated Systems and Methods,” U.S. patent application Ser. No. 17/170,752, filed Feb. 8, 2021, entitled “Planter Obstruction Monitoring and Associated Devices and Methods,” U.S. patent application Ser. No. 17/225,586, filed Apr. 8, 2021, entitled “Devices, Systems, and Methods for Corn Headers,” U.S. Pat. No. 11,758,848, issued Sep. 19, 2023, entitled “Devices, Systems, and Methods for Sensing the Cross Sectional Area of Stalks,” U.S. patent application Ser. No. 17/323,649, filed May 18, 2021, entitled “Assisted Steering Apparatus and Associated Systems and Methods,” U.S. patent application Ser. No. 17/369,876, filed Jul. 7, 2021, entitled “Apparatus, Systems, and Methods for Grain Cart-Grain Truck Alignment and Control Using GNSS and/or Distance Sensors,” U.S. patent application Ser. No. 17/381,900, filed Jul. 21, 2021, entitled “Visual Boundary Segmentations and Obstacle Mapping for Agricultural Vehicles,” U.S. patent application Ser. No. 17/461,839, filed Aug. 30, 2021, entitled “Automated Agricultural Implement Orientation Adjustment System and Related Devices and Methods,” U.S. patent application Ser. No. 17/468,535, filed Sep. 7, 2021, entitled “Apparatus, Systems, and Methods for Row-by-Row Control of a Harvester,” U.S. patent application Ser. No. 17/526,947, filed Nov. 15, 2021, entitled “Agricultural High Speed Row Unit,” U.S. patent application Ser. No. 17/566,506, filed Dec. 20, 2021, entitled “Devices, Systems, and Method For Seed Delivery Control,” U.S. patent application Ser. No. 17/576,463, filed Jan. 14, 2022, entitled “Apparatus, Systems, and Methods for Row Crop Headers,” U.S. patent application Ser. No. 17/724,120, filed Apr. 19, 2022, entitled “Automatic Steering Systems and Methods,” U.S. patent application Ser. No. 17/742,373, filed May 11, 2022, entitled “Calibration Adjustment for Automatic Steering Systems,” U.S. patent application Ser. No. 17/902,366, filed Sep. 2, 2022, entitled “Tile Installation System with Force Sensor and Related Devices and Methods,” U.S. patent application Ser. No. 17/939,779, filed Sep. 7, 2022, entitled “Row-by-Row Estimation System and Related Devices and Methods,” U.S. patent application Ser. No. 18/215,721, filed Jun. 28, 2023, entitled “Seed Tube Guard and Associated Systems and Methods of Use,” U.S. patent application Ser. No. 18/087,413, filed Dec. 22, 2022, entitled “Data Visualization and Analysis for Harvest Stand Counter and Related Systems and Methods,” U.S. patent application Ser. No. 18/097,804, filed Jan. 17, 2023, entitled “Agricultural Mapping and Related Systems and Methods,” U.S. patent application Ser. No. 18/101,394, filed Jan. 25, 2023, entitled “Seed Meter with Integral Mounting Method for Row Crop Planter and Associated Systems and Methods,” U.S. patent application Ser. No. 18/102,022, filed Jan. 26, 2023, entitled “Load Cell Backing Plate and Associated Devices, Systems, and Methods,” U.S. patent application Ser. No. 18/116,714, filed Mar. 2, 2023, entitled “Cross Track Error Sensor and Related Devices, Systems, and Methods,” U.S. patent application Ser. No. 18/203,206, filed May 30, 2023, entitled “Seed Tube Camera and Related Devices, Systems and Methods,” U.S. patent application Ser. No. 18/209,331, filed Jun. 13, 2023, entitled “Apparatus, Systems and Methods for Image Plant Counting,” U.S. patent application Ser. No. 18/217,216, filed Jun. 30, 2023, entitled “Combine Unloading On-The-Go with Bin Level Sharing and Associated Devices, Systems, and Methods,” U.S. patent application Ser. No. 18/229,974, filed Aug. 3, 2023, entitled “Hydraulic Cylinder Position Control for Lifting and Lowering Towed Implements,” U.S. patent application Ser. No. 18/230,534, filed Aug. 4, 2023, entitled “Single-Step Seed Placement in Furrow and Related Devices, Systems, and Methods,” U.S. patent application Ser. No. 18/238,344, filed Aug. 25, 2023, entitled “Combine Yield Monitor Automatic Calibration System and Associated Devices and Methods,” U.S. patent application Ser. No. 18/367,929, filed Sep. 13, 2023, entitled “Hopper Lid with Magnet Retention and Related Systems and Methods,” U.S. patent application Ser. No. 18/516,514, filed Nov. 21, 2023, entitled “Stalk Sensors and Related Devices, Systems, and Methods,” U.S. patent application Ser. No. 18/441,708, filed Feb. 14, 2024, entitled “Liquid Flow Meter and Flow Balancer and Associated Devices, Systems, and Methods,” U.S. patent application Ser. No. 18/662,800, filed May 13, 2024, entitled “Devices, Systems, and Methods for Providing Yield Maps,” U.S. patent application Ser. No. 18/665,305, filed May 15, 2024, entitled “Devices, Systems, and Methods for Agricultural Guidance and Navigation,” U.S. patent application Ser. No. 18/761,041, filed Jul. 1, 2024, entitled “Ring Assembly For Automatic and/or Assisted Steering and Associated Systems and Methods,” U.S. patent application Ser. No. 18/776,374, filed Jul. 8, 2024, entitled “Assisted Steering Systems and Associated Devices and Methods for Agricultural Vehicles,” U.S. patent application Ser. No. 18/929,309, filed Oct. 28, 2024, entitled “Agricultural Implement Position Sensor and Related Devices, Systems, and Methods,” U.S. Patent Application 63/607,227, filed Dec. 7, 2023, entitled “Header Height Control Devices, Systems and Methods,” U.S. Patent Application 63/609,758, filed Dec. 13, 2023, entitled “Magnetic Stripper/Deck Plate Sensing System,” U.S. Patent Application 63/626,744, filed Jan. 30, 2024, entitled “Grain Cart Unloading Sensor and Unload Control,” U.S. Patent Application 63/646,038, filed May 13, 2024, entitled “Seed Tube Camera and Related Devices, Systems, and Methods,” U.S. Patent Application 63/646,068, filed May 13, 2024, entitled “Seed Tube Camera and Related Devices, Systems, and Methods,” U.S. Patent Application 63/651,831, filed May 24, 224, entitled “Non-Contact Methods for Interactions in Navigational Space of Relatively Located Mobile Systems, and Related Devices and Systems,” U.S. Patent Application 63/654,634, filed May 31, 2024, entitled “Equipment Thermal Monitoring System and Associated Methods and Devices,” U.S. Patent Application 63/667,546, filed Jul. 3, 2024, entitled “Cover for Port Openings,” U.S. Patent Application 63/667,530, filed Jul. 3, 2024, entitled “Agricultural Seed Meters and Related Devices, Systems and Methods,” U.S. Patent Application 63/685,000, filed Aug. 20, 2024, entitled “Crop Sensor Wands and Related Devices, Systems, and Methods,” U.S. Patent Application 63/682,229, filed Aug. 12, 2024, entitled “Integrated Crop Sensor and GPS Steering Systems and Related Devices and Methods,” U.S. Patent Application 63/683,149, filed Aug. 14, 2024, entitled “Seed Tube Camera and Related Devices, Systems, and Methods,” U.S. Patent Application 63/710,492, filed Oct. 22, 2024, entitled “Crop Sensors and Related Devices, Systems, and Methods,” U.S. Patent Application 63/710,641, filed Oct. 23, 2024, entitled “Agricultural Sprayer Boom Flush, Chemical Detection and Chemical Concentration Detection,” U.S. Patent Application 63/720,611, filed Nov. 14, 2024, entitled “Liquid Product Distribution for See and Spray Systems,” U.S. Patent Application 63/722,916, filed Nov. 20, 2024, entitled “Agricultural Harvesting Systems and Related Devices and Methods,” U.S. Patent Application 63/722,934, filed Nov. 20, 2024, entitled “Sprayer PWM Nozzle Valve Pressure Drop Mitigation,” U.S. Patent Application 63/723,400, filed Nov. 21, 2024, entitled “Systems, Methods and Devices for Increasing Machine Operating Range Using PWM and Dynamic Pressure Range Control,” U.S. Patent Application 63/723,436, filed Nov. 21, 2024, entitled “Seed Tube Camera and Related Devices, Systems, and Methods,” each of which is incorporated herein by reference.

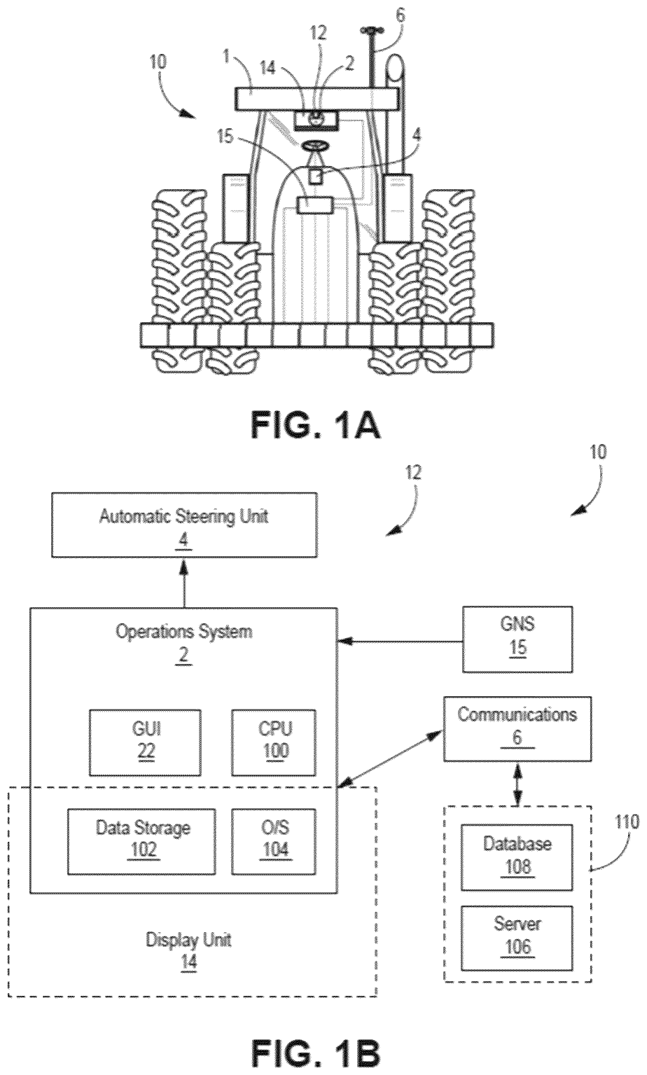

Turning to the drawings in greater detail, FIGS. 1A-1B depict exemplary implementations of the various visualization and guidance system 10 components fitted to an agricultural vehicle 1. In various implementations, the agricultural vehicle 1 may be a tractor 1, optionally having an implement such as a planter or sprayer, as would be understood. The agricultural vehicle 1 may also be a harvester, such as a combine. It is understood that a variety of vehicles 1 and implements can be utilized in various implementations. It is further understood that the components depicted in FIGS. 1A-1B are optional, and can be utilized or omitted in the various claimed implementations, and that certain additional components may be required to effectuate the various processes and systems described herein. Such additional components may include hardware, software, firmware, and other electronic components that would be known and appreciated by those of skill in the art.

As shown in FIG. 1A, the visualization and guidance system 10 has an operations system 2 that comprises or is configured to be operationally integrated with a steering unit 4, such as SteerCommand®, and an optional communications component 6. The system 10 may be operationally integrated with at least one in-cab display 14, such as an InCommand® display 14, or other suitable display 14 understood in the art. It is appreciated that certain of these displays 14 feature touchscreens, while others are equipped with necessary components for interaction with the various prompts and adjustments discussed herein, such as via a keyboard or other interface.

In various implementations, the system 10 is also operationally integrated with a GNSS or GPS unit 15, such as a GPS 7500, such that the system 10 is configured to input positional data for use in defining boundaries, locating the tractor 1, plotting guidance, adjusting guidance, and the like, as would be readily appreciated from the present disclosure.

As shown in FIG. 1B, in various implementations, the operations system 2 is optionally in operational communication with the automatic steering unit 4 or controller 4, the communications component 6, and/or GNSS 15. In certain of these implementations, the operations system 2 is housed in the display 14, though the various components described herein can be housed elsewhere, as would be readily appreciated.

As shown in FIG. 1B, the operations system 2 further has one or more optional processing and computing components, such as a CPU/processor 100, data storage 102, operating system 104, and other computing components necessary for implementing the various technologies disclosed herein. It is appreciated that the various optional system components are in operational communication with one another via wired or wireless connections and are configured to perform the processes and execute the commands described herein.

In certain implementations, like that of FIG. 1B, the communications component 6 is configured for the sending and receiving of data for cloud 110 storage and processing, such as to a remote server 106, database 108, and/or other cloud computing components readily understood in the art. Such connections by the communications component 6 can be made wirelessly via understood internet and/or cellular technologies such as Bluetooth, WiFi, LTE, 3G, 4G, or 5G connections and the like. It is understood that in certain implementations, the communications component 6 and/or cloud 110 components comprise encryption or other data privacy components such as hardware, software, and/or firmware security aspects. In various implementations, the operator or enterprise manager or other third parties are able to receive notifications via their mobile phones or other devices.

It would be understood in light of this disclosure, that the various implementations of the guidance path system 10 comprises a variety of optional steps and sub-steps for automating path adjustment, plotting, and execution. Further, while each of the steps and sub-steps are described herein in an order, the various steps and sub-steps may be performed in alternate orders or simultaneously with one another, and each of the various steps is optional and can be omitted. Further, it is readily appreciated that the various steps may be iterated upon, such as when moving from one field map to the next, transmitting and receiving information, and plotting and adjusting successive paths and crop row locations.

Various of the optional steps and sub-steps described in the guidance path system 10, can be performed manually, via automation or calculation, or can be retrieved or commanded remotely, as would be readily understood. Further, the various optional steps and sub-steps described herein may be performed contemporaneously or sequentially in any order and in certain implementations iteratively, as would be readily appreciated.

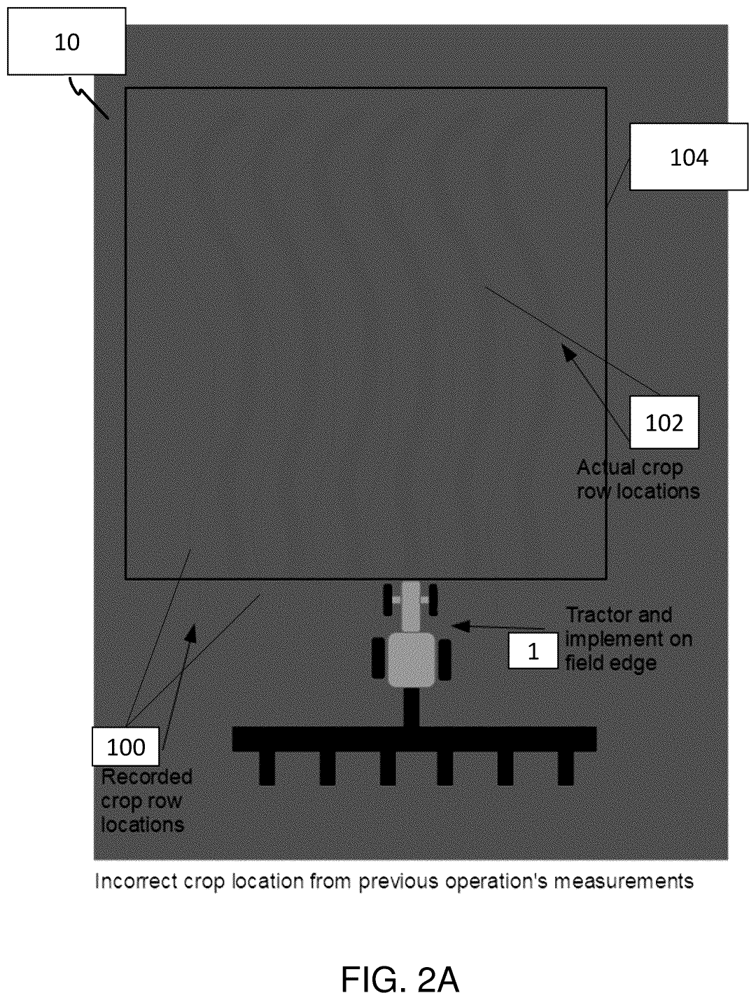

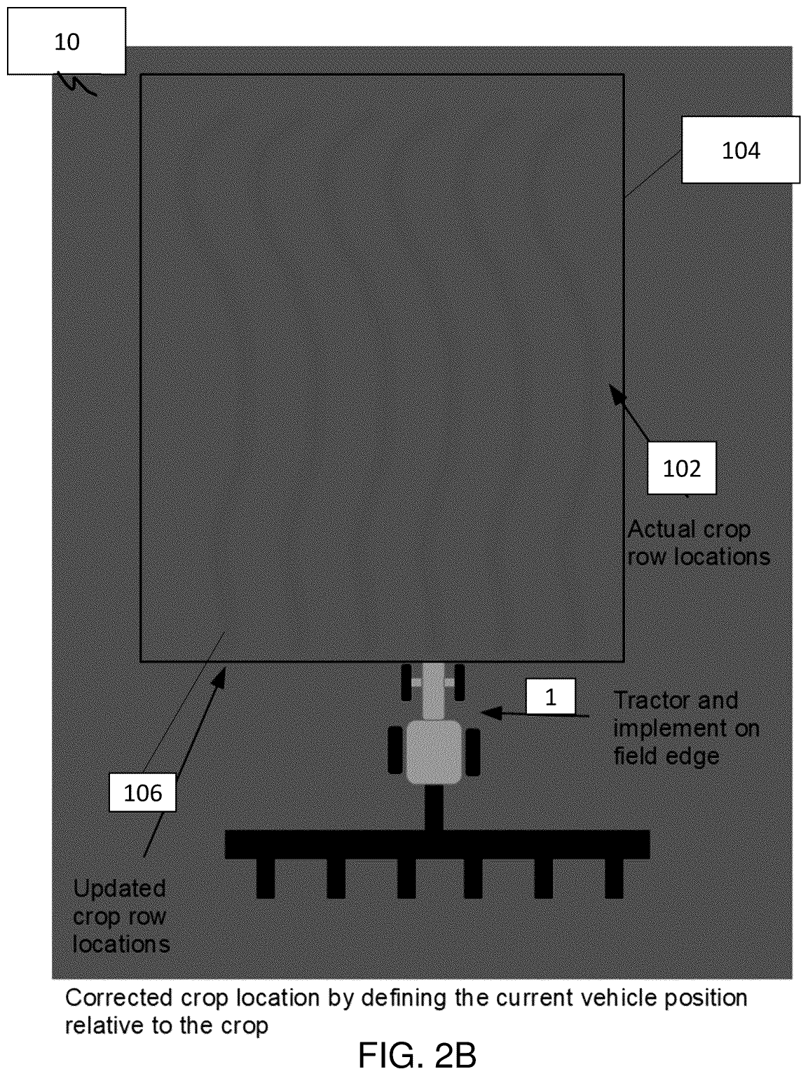

As used herein a “nudge” or “nudges” refers to adjustments to, movement of, or shifting of a guidance path and/or crop row location based on real world conditions from previous or stored guidance paths and/or crop row location. It is understood that “nudges” can be required at any point in the field to adjust for transient errors due to shifting GNSS position errors, changes in a trailing implement position, terrain slope, tire side slip, etc. See, e.g., FIGS. 2A and 2B.

Here FIG. 2A shows an exemplary field where the recorded crop row locations 100 are different from the observed actual crop row locations 102 in a field 104. As can be seen, the deviation is in both the lateral and longitudinal directions. These errors in the recorded crop location can be from a number of factors that are discussed elsewhere herein and would be appreciated by those of skill in the art. The recorded crop row locations may be derived from data from previous agricultural operations, such as planting, as would be readily understood.

The observed transient errors during subsequent operations can be the result of several causes. That is, as one example, there can be error in the recorded crop location estimates from the previous operation estimate, or if there is error in the current operation estimate as a result of the implement position in the global reference frame. When a nudge occurs as described below, crop location error from previous passes is corrected by adjusting both the crop and guidance line locations.

Prior known implement position error corrections were made by only moving the guidance line, but not the crop location. That is, lateral nudges were the only adjustments normally available to an operator on a standard guidance line. But, while the vehicle is within the crop rows, longitudinal adjustments are difficult due to the lack of clear longitudinal reference points.

However, under certain implementations of the disclosed system 10, longitudinal adjustments can be accurately applied at the beginning and end of the crop row 102 or field edge 104. In certain implementations, longitudinal nudges (along the vehicle axis) are made by placing a reference point on the vehicle 1 at the edge of the field 104 or the start of rows 102 then updating the stored crop location field edge to match. See, e.g., FIG. 2B.

In FIG. 2B it can be seen that the system 10 detected that the previous recorded crop row locations 100 (from FIG. 2A), were different from the actual crop row locations 102. In this implementation, the system 10 applied a nudge at the edge of the field 104 to update the crop row location 106 to match the actual crop row locations 102. By updating the crop row locations 106 relative to the vehicle 1, the system 10 can then generate more accurate guidance path from the vehicle to traverse the field 104 to perform further operation efficient and efficiently, as would be understood.

Alternatively, crop sensors mounted on a vehicle or implement can be used by the system 10 to update the previously recorded locations. These sensors are often used for agronomic purposes, such as detecting weeds, counting plants, or fine-tuning steering guidance. These sensors detect the crop and can be used to update the crop location. Various crop sensors are discussed in certain of the incorporated references and would be known and appreciated by those of skill in the art. Crop sensor may be contact, mechanical crop sensors, such as feelers or wands. Crop sensors may also be vision, LiDAR, laser, or other non-contact type sensor. Adjustment made using differences in crop location detected by crop sensors may in some implementations be restricted to an area around the detected crop, for example only updating a small area, such as a single swath of the current implement. Additionally or alternatively, the adjustments made using difference in crop locations detected by crop sensors may be used to update a larger area, including the entire field or surrounding fields. See FIGS. 2A and 2B.

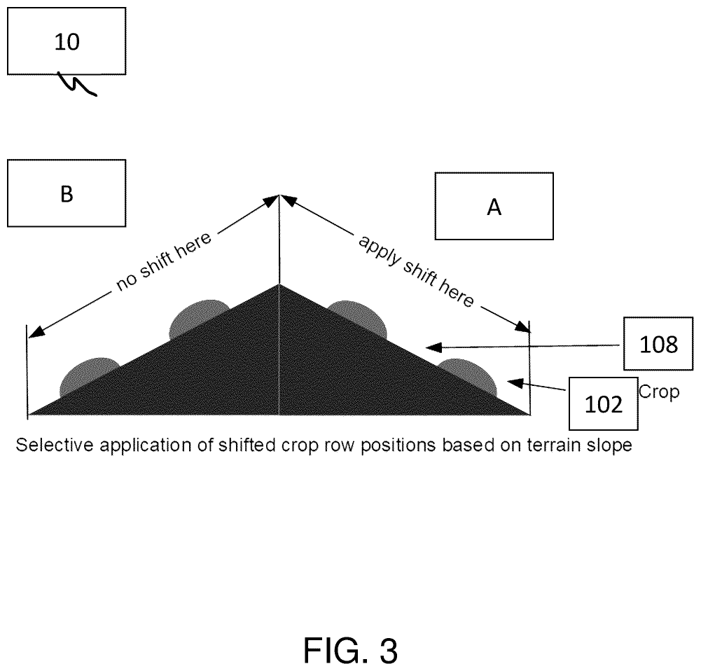

Some crop location adjustments/nudges can be applied to localized areas/segments of the crop/field 104. Which area of the crop that should be nudged may be selected by certain additional factors. For example, initial lateral and longitudinal nudges at the edge of the field can be applied to the entire field (see the example of FIGS. 2A and 2B). In another example, if the current vehicle is on a side of a hill, the nudge can apply to all the other crops on the side of the hill. Determination of a hill or slope may be based on a topographical map, the orientation of the original operation vehicle, or updated in real-time based on current vehicle tilt. See, e.g. FIG. 3.

In FIG. 3, a shift/nudge is applied to side A of the sloped terrain 108 to match the actual crop location 102 with the recorded crop location 100 for generation of guidance paths. The adjustment on side A of the sloped terrain 108 is not applied to side B of the sloped terrain 108. This is because the shift/nudge may not be necessary on side B or the shift/nudge may be different for side B given the difference in terrain topology. The system 10 may utilize a topographical map, recorded vehicle orientations from prior traversal of the area, or real time data to segment a field into sections of similar topology for application of shifts/nudges.

In some implementations, if there is a change in the GNSS correction signal, the shift/nudge can be applied to all the crops planted after the correction signal change. This correction change can be a large change in the correction value or in the correction source itself.

If the estimated crop location has shifted, the system, in various implementations, is configured to evaluate the estimates—the previous operation estimate or current operation estimate—for accuracy and proceed with the more accurate estimate. The system may be configured to establish this through several approaches.

For example, in certain implementations the system can choose the estimate with the best GNSS position accuracy/correction under the various approaches for these corrections understood in the art, such as various types of fixed and floating RTK (real-time kinematic) corrections, WAAS (wide are augmentation system), and SBAS (Satellite Based Augmentation System) approaches, among others. It is understood that each of these correction types provides some estimates on correction quality. Some of approaches are based on how many GNSS satellites are visible to the antenna and what their arrangement is. These metrics are the geometric dilution of precision (GDOP). Examples are horizontal (HDOP), vertical (VDOP), precision (PDOP) which is vertical and horizontal combined, as well as time dilution of precision (PDOP). Other metrics include how frequently updates are received (i.e. 5 hz, 10 hz, 20 hz, and the like) or how long a correction takes to arrive (AOD—age of differential).

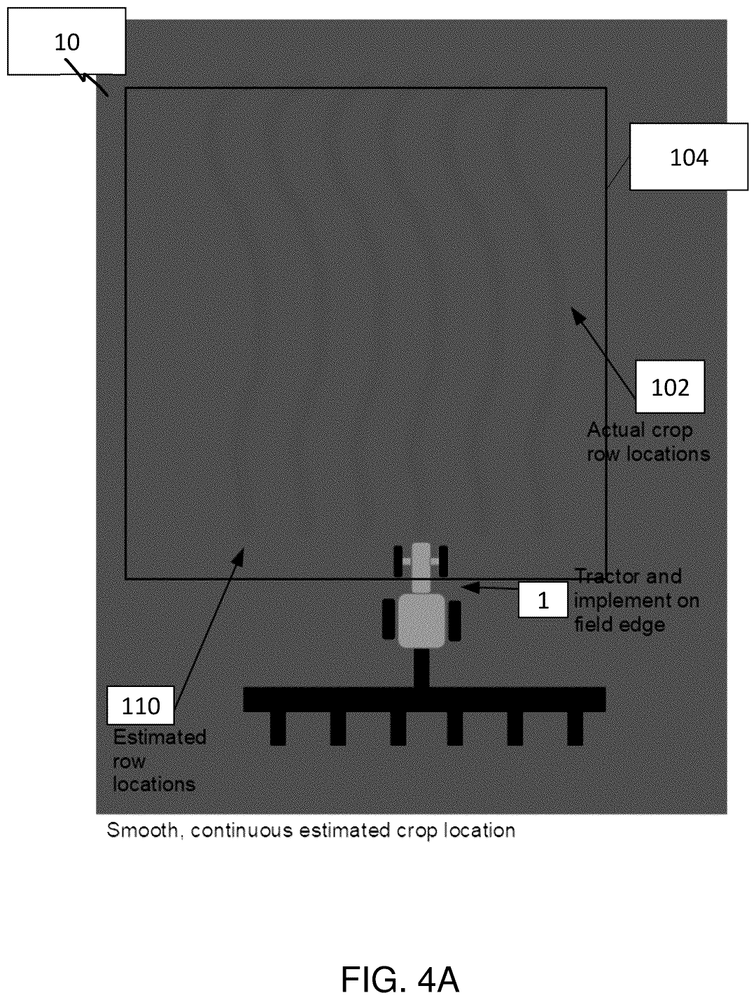

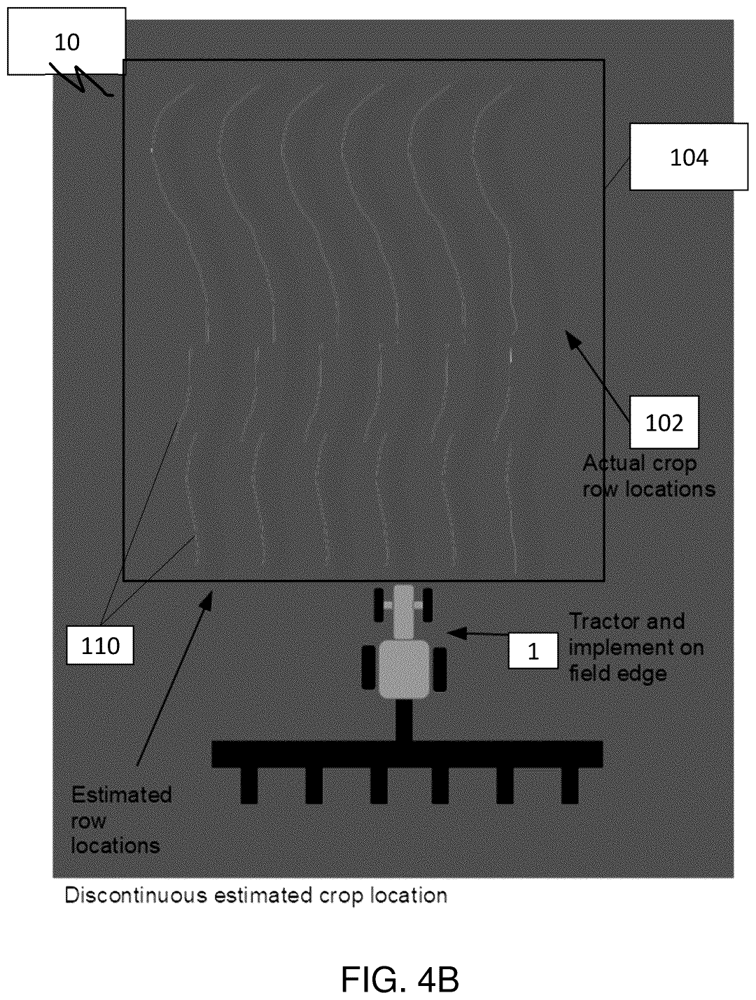

When used for row crops, the system 10 is configured to determine which GNSS source provides a more physically realistic/accurate estimate of the crop rows throughout the field. If one operation estimates smooth, continuous crop rows and the other operation estimates crop rows with discontinuities, the system would select the first estimate as the correct one. See, e.g., FIGS. 4A and 4B.

In FIG. 4A it can be seen that the estimated row locations 110 are smooth, continuous, and generally follow the actual crop locations 102, In FIG. 4B it can be seen that the estimated row location 110 are disjointed, deviating from the actual crop locations 102 at different magnitudes at different points along the row.

In implementations where a Kalman filter is used, the estimate with the lowest residuals may be utilized. Alternatively, other metrics of state estimation quality, such as lower biases can be used, as would be appreciated by those of skill in the art.

Further implementations of the system 10 may utilize an average position from all the operations performed over the course of a season or in certain implementations between seasons, as would be appreciated. Other statistical methods like the median can also be utilized, as would also be understood.

In further approaches, the system 10 evaluates all previous year operations to determine estimate accuracy by evaluating whether any of the implements or operations estimated crop positions differed in a statistically meaningful way from the rest of the population. If so, the system 10 may be configured to discard the outlier implement and/or operation to modify the estimated crop location and evaluate error.

Certain implementations of the system 10 records all/more than one GNSS correction sources periodically. That is, the system 10 may record data from multiple sources to be used to calculate offsets if the preferred correction is unavailable. For example, the planting operation was performed with a dedicated RTK base station on the field, but the WAAS and local NTRIP corrections were also recorded during that time. Depending on which correction is used, there is some shift in the calculated GNSS vehicle position. During the second operation, the local RTK base station is unavailable, so NTRIP correction is used. Before starting the operation, the offset between the dedicated base station and NTRIP from the first operation is applied to the crop location.

Certain implementations of the system 10 record all GNSS antenna mounting location adjustments used to correct the track-on-track error (roll error)—can be used to calculate offsets between other vehicles with different mounting location adjustments. In certain aspects, the system applies the location offset to the crop location.

Certain implementations of the system record a first vehicle's orientation to identify field topography and apply targeted crop location corrections for subsequent use.

Certain implementations of the system 10 segments field location adjustments based on soil type, planted crop population density, prior year yield maps, active implement steering parameters from previous operations, planting depth from previous operations, recorded vehicle wheel slip from previous operations, crop type, crop treatment, and recorded prior operation timing (such a time of planting).

Various implementations allow the user to select any of the crop location adjustment methods. Or manually select the location affected on a map.

Once nudges are applied and adjustments made by the system 10, the system 10 may command an automatic steering unit 4 to traverse corrected guidance paths. As would be understood an automatic steering unit 4 may operate autonomously or semi-autonomously along plotted guidance paths.

That is, the disclosed system 10 can generally be utilized to generate paths for use by agricultural vehicles as the vehicle 1 traverses a field. It is understood that as discussed herein, a guidance path 10 can relate to the route to be taken by the center of an agricultural implement so as to plot a path through a field or elsewhere to conduct an agricultural operation, as would be readily appreciated by those familiar with the art.

In these implementations, the vehicle guidance paths may include heading and position information, such as GPS coordinates indicating the location(s) where the tractor and/or other vehicle should be driven for proper placement within a field, such as between the crop rows, as has been previously described. It would be appreciated that various agricultural vehicles include a GPS unit for determining the position of the vehicle within a field at any given time. This GPS unit may work in conjunction with the system, and optionally an automatic steering system, to negotiate the tractor or other vehicle along the guidance paths, as would be appreciated.

Although the disclosure has been described with references to various embodiments, persons skilled in the art will recognize that changes may be made in form and detail without departing from the spirit and scope of this disclosure.

What is claimed is:

1. A method for locating crop row and generating vehicle guidance paths:
comparing a recorded crop row location to an actual row location;
adjusting the crop row location such that the recorded crop row location is aligned with the actual crop row location;
generating guidance paths for a vehicle using the adjusted crop row locations; and
commanding the vehicle to traverse the generated guidance paths via an automatic steering system.

2. The method of claim 1, wherein the recorded crop row location is taken from data recorded during planting operations.

3. The method of claim 1, wherein the actual crop row location is determined by a mechanical crop sensor.

4. The method of claim 1, wherein the adjustment is applied to an entire field.

5. The method of claim 1, wherein the adjustment is applied to only a segment of a field.

6. The method of claim 1, further comprising selecting a most accurate crop location estimate from the recorded crop row location and a current operation estimate.

7. The method of claim 1, wherein the recorded crop row location includes data from two or more GNSS sources, further comprising determining a most accurate source from the two or more GNSS sources.

8. The method of claim 7, wherein the most accurate source is selected by applying a Kalman filter.

9. The method of claim 1, further comprising discarding outlier recorded crop locations.

10. An adjustment system for guidance lines comprising:
(a) a GNSS unit disposed on an agricultural vehicle;
(b) a memory comprising stored crop row locations;
(c) a processor in communication with the GNSS unit and the memory, the processor configured to apply lateral and/or longitudinal adjustments to guidance lines generated based on stored crop row locations from a prior operation; and
(d) an automatic steering system configured to command the agricultural vehicle to traverse the guidance lines.

11. The adjustment system of claim 10, further comprising a crop sensor configured to detect an actual location of a crop row.

12. The adjustment system of claim 11, wherein the crop sensor is a mechanical, contact sensor.

13. The adjustment system of claim 10, wherein lateral and/or longitudinal adjustment are applied to an entire field.

14. The adjustment system of claim 10, wherein lateral and/or longitudinal adjustment are applied to a segment of a field.

15. The adjustment system of claim 10, wherein the field is segmented by one or more of topology, crop type, crop treatment, soil type, planted crop population density, prior year yield maps, active implement steering parameters from prior operations, planting depth, recorded vehicle wheel slip, and prior operation timing.

16. The adjustment system of claim 10, wherein the GNSS unit is configure to record data from multiple sources continuously or periodically.
